(19) United States
(12) Patent Application Publication
(10) Pub. No.: US 2021/0362461 A1
(43) Pub. Date: Nov. 25, 2021

(54) THREE-DIMENSIONAL THERMOPLASTIC SANDWICH PANEL COMPOSITE

(71) Applicant: LOW & BONAR B.V., Arnhem (NL)

(72) Inventors: Joris VAN DER EEM, Arnhem (NL); Jan MAHY, Arnhem (NL)

(73) Assignee: LOW & BONAR B.V., Arnhem (NL)

(21) Appl. No.: 17/273,393

(22) PCT Filed: Sep. 10, 2019
(86) PCT No.: PCT/EP2019/074113

§ 371 Date: Mar. 4, 2021

(30) Foreign Application Priority Data
Sep. 10, 2018 (EP) PCT/EP2018/074302

(51) Int. Cl. B32B 3/12; B32B 5/02; B32B 27/12; B32B 27/08; B32B 27/32; B32B 27/36; B32B 37/14

(52) U.S. Cl. CPC B32B 3/12; B32B 2367/00; B32B 27/12; B32B 27/08; B32B 27/32; B32B 27/36; B32B 37/146; B32B 2307/732; B32B 2262/144; B32B 2605/003; B32B 2262/0284; B32B 2262/0253; B32B 2307/718; B32B 2250/04; B32B 2250/05; B32B 2250/24; B32B 2250/40; B32B 2262/124; B32B 2307/54; B32B 2605/08; B32B 2323/10; B32B 5/022

(57) ABSTRACT

A composite structure for interior lining includes a honeycomb structure having a first main surface and a second main surface, a first nonwoven layer of fibers bonded to the honeycomb structure at the first main surface or the second main surface. The honeycomb structure and the first nonwoven layer of fibers include thermoplastic polymeric materials. The honeycomb structure is provided from an uncut flat body and includes a plurality of honeycomb cells, and the honeycomb cells are delimited by walls. A film, including a thermoplastic polymeric material, is located in the composite structure between the first nonwoven layer of fibers and the honeycomb structure and/or bonded to the honeycomb structure at the main surface opposite to the main surface at which the first nonwoven layer of fibers is bonded to the honeycomb structure.

The invention pertains to a composite structure for interior linings having improved acoustic properties and a method of producing such composite structure.

Since the first patented automobile of Carl Benz in 1878, the development of the automobile was going to faster and bigger automobiles. Even the comfort was increased, by adding convenient car seats, air conditioning systems as well as protecting systems like air bags or three-point belts.

The advent of faster and heavier cars has resulted in an increase in the amount of noise, especially within the passenger compartment. Noise-related “pollution” has been named as one of the main origins of human illness and even fatality by the World Health Organization. Road traffic is the biggest cause of community noise in most cities as well as for noise in the interior of cars.

Exposure to noise is responsible for a range of health effects, including increased risk of ischemic heart disease as well as sleep disturbance, cognitive impairment among children, annoyance, stress-related mental health risks, and tinnitus. Taken together these risks in high-income European countries account for a loss of 1-1.6 million disability adjusted life years (DALYs)—a standardized measure of healthy years of life lost to illness, disability or early death.

While road traffic is the most pervasive noise-related issue, children living in areas with high aircraft noise have delayed reading ages, poor attention levels, and high stress levels.

This traffic-related noise issue is also relevant for the occupants of the interior of cars. As car occupancy increases and a car increasingly becomes part of the urban professional's working place, the noise level inside a car is increasingly being addressed.

In particular, structural (vibration related) and airborne noise in the frequency range below about 1000 Hz, more specifically between 100 and 500 Hz, is both clearly audible to the human ear and difficult to suppress. Although the decoupling of combustion-engine related vibrations from the automobile passenger compartment has been very successful, and simultaneously new generation combustion engines are generating much less vibration-related sound, the environmental (mainly tire- and wind-related) airborne noise levels are deemed too high for comfortable driving conditions.

Therefore, there is still a demand for improving the acoustic properties of sound insulation in cars to create a more comfortable stay in the automobile. The advent of electrical engines (no combustion-related sound) and autonomous driving is expected to (1) increase the passenger's sensitivity for other, environmental, noise and (2) increase the need for comfort and leisure while (being) driven. Active noise cancelling headphones are already common for commuters and in particular aircraft passengers (where noise is an even more dominant phenomenon). The need to communicate between passengers, or to enjoy music and entertainment during transport is expected to require specific noise suppression, i.e. in specific frequency ranges. To this end, cabin interior panels and lining are increasingly equipped with acoustic properties which cancel or suppress those frequency ranges associated with environmental (outside, engine) noise while providing optimal sound e.g. in the human voice and music/entertainment related frequency ranges.

Structural borne noise arises from tire/road interaction and the engine. Structural borne noise prevails at below 500 Hz. Also, it is the largest contributor to the overall noise.

From a material standpoint it would be beneficial to use materials with high density and low dynamic modulus to reduce structural borne noise, however this is contrary to what is desired for the lightweight structural elements. Structural borne sound is therefore more easily controlled by structural design than material design.

Airborne sound, however, can be reduced by sound absorption, i.e. material design. Airborne noise prevails at above 500 Hz.

Airborne noise can be reduced via sound barriers and sound absorbers. Because sound insulation performance is highly dependent on mass, the sound quality is often improved by adding lightweight sound absorbers.

EP 1 255 633 B1 discloses a building component for a parcel shelf for sound insulation in cars. The parcel shelf comprises a honeycomb structure, wherein on both sides of the honeycomb structure a nonwoven layer of thermoplastic fibers is bonded and further decorative layers can be added. The building component has a high bending stiffness.

EP 0 883 520 B1 discloses a recyclable headliner material formed of a single type of plastic. The recyclable headliner comprises a core of a honeycomb structure and needled nonwoven layer of fibers on both sides of the honeycomb structure. Due to recyclability the components of the recyclable headliner are made of the same thermoplastic polymeric material.

WO 2011/045364 A1 discloses a sandwich construction for automotive application as thermal and/or acoustic insulation. The sandwich construction is made of a honeycomb core covered on both sides with a layer of needled nonwovens and the honeycomb core and the needled nonwovens are made of thermoplastic polymeric material.

The prior art shows composites which have high bending stiffnesses e.g. EP 1 255 633 B1, but the moldability of such composites is poor due to the stiffness or after molding the stiffness of the composite is deteriorated.

The object of the invention is to provide a composite structure for interior lining and a method of producing such composite structure having beneficial acoustic properties, which reduces the drawbacks of the prior art.

The object of the invention is solved by a composite structure for interior lining comprising a honeycomb structure having a first main surface and a second main surface, a first nonwoven layer of fibers bonded to the honeycomb structure at the first main surface or the second main surface, wherein the honeycomb structure and the first nonwoven layer of fibers comprise thermoplastic polymeric materials, wherein the honeycomb structure is provided from an uncut flat body and comprises a plurality of honeycomb cells, and the honeycomb cells are delimited by walls, characterized in that a film, comprising a thermoplastic polymeric material, is located in the composite structure between the first nonwoven layer of fibers and the honeycomb structure and/or bonded to the honeycomb structure at the main surface opposite to the main surface at which the first nonwoven layer of fibers is bonded to the honeycomb structure.

A synonymous name for the composite structure can be a three-dimensional (3D) sandwich panel composite for interior lining.

Within the scope of the invention, a nonwoven is defined according to the definition of the EDANA: “A nonwoven is a sheet of fibers, continuous filaments, or chopped yarns of any nature or origin, that have been formed into a web by any means, and bonded together by any means, with the exception of weaving or knitting. Felts obtained by wet milling are not nonwoven.”

In a preferred embodiment, a second nonwoven layer of fibers, which comprises thermoplastic material, is bonded to the honeycomb structure at the main surface opposite to the main surface at which the first nonwoven layer of fibers is bonded to the honeycomb structure.

The honeycomb structure provided from an uncut flat body can be provided as for example disclosed by WO 2006/053407 A1. This honeycomb structure can be produced from an uncut flat body, which comprise a thermoplastic polymer by plastic deformation perpendicular to the plane of the material such that three-dimensional (3D) structures and connection areas are formed, i.e. half-hexagonal cell walls and small connection areas are formed (FIG. 8). Subsequently, the 3D-structures are folded towards each other to form cells having cell walls adjoin one another in the form of a honeycomb cell.

Thereby, two in machine direction consecutive honeycomb cells have separate cell walls (802 and 803), which adjoin each another and which are connected to each other at a shared boundary rib (805) in the first main surface or in the second main surface.

Preferably, the two separate adjoining cell walls (802 and 803) of two in machine direction consecutive honeycomb cells are bonded together, more preferably the bonding is performed by any suitable process, even more preferably the bonding is performed thermally, chemically and/or mechanically, and most preferably the bonding is performed thermally.

Without being bound theory, it is believed that if the two separate adjoining cell walls (802 and 803) of two in machine direction consecutive honeycomb cells are bonded together, the bending stiffness of the composite can be increased.

In another preferred embodiment, the two separate adjoining cell walls (802 and 803) of two in machine direction consecutive honeycomb cells are solely connected to each other at a shared boundary rib (805) in the first main surface or in the second main surface.

Without being bound to theory, it is believed that if the two separate adjoining cell walls (802 and 803) of two in machine direction consecutive honeycomb cells are solely connected to each other by a shared boundary rib (805) in the first main surface or a second main surface, the composite can have an increased flexibility and also an increased moldability.

Preferably, the formed honeycomb cells are closed at one end of the honeycomb cell, more preferably, a half of the honeycomb cells are closed at one end in the first main surface of the honeycomb structure and another half of the honeycomb cells are closed at one end in the second main surface of the honeycomb structure, even more preferably the honeycomb cells are closed at only one end. As the honeycomb cells can be closed at one end, the honeycomb structure can be water impermeable over its entire extension. Further, due to fact that the honeycomb cells are closed at one end, void volumes are established which can be separated into at least two groups of void volumes by the honeycomb structure provided from an uncut flat body.

In another preferred embodiment, the honeycomb cells of the honeycomb structure provided from an uncut flat body may be provided with holes in the closed ends in the first main surface or in the second main surface to provide water permeability and air permeability to the honeycomb structure.

In a further preferred embodiment, the honeycomb cells of the honeycomb structure provided from an uncut flat body are open at both ends.

Without being bound to theory, it is believed that due to the fact that the honeycomb structure is provided from an uncut flat body by plastically deforming and folding of the uncut flat body, the formability or moldability, in particular thermoformability, of the composite structure can be enhanced. In the case the honeycomb structure undergoes an extension in a direction, which can occur in a molding process, the honeycomb cells can deform in the extension direction and in the other direction the honeycomb cells can remain their form. Further, it is believed that a shrinkage of the composite structure can be reduced by the rigidity of the structure of the honeycomb cells of the honeycomb structure

The terms “formability”, “moldability” and “thermoformability” are used synonymously in the description.

Also without being bound to theory, it is believed that the film located between the first nonwoven layer of fibers and the honeycomb structure and/or bonded to the honeycomb structure at the main surface opposite to the main surface at which the first nonwoven layer of fibers is bonded to the honeycomb structure increases the bending stiffness of the composite, and the film, if located between the first nonwoven layer of fibers and the honeycomb structure, increases the bonding between the first nonwoven layer of fibers and the honeycomb structure. Further, it is believed that the film can also increase the sound insulation due to increased reflection of the noise.

The bonding between the first nonwoven layer of fibers and the honeycomb structure, and/or between the second nonwoven layer of fibers and the honeycomb structure can be established thermally, chemically mechanically, or a combination thereof. Preferably, the bonding between the first nonwoven layer of fibers and/or the honeycomb structure, and the second nonwoven layer of fibers and the honeycomb structure is established by the application of heat, i.e. thermally. Any suitable method can be used for the application of heat, preferably heat is applied by conduction, convection, radiation, lamination, calendaring. Typically for the application of heat a hot air oven or an electromagnetic radiator (e.g. an infrared-heater) can be used.

Within the scope of the present invention it is understood that the term fibers refers to both staple fibers and filaments. Staple fibers are fibers which have a specified, relatively short length in the range of 2 to 200 mm. Filaments are fibers having a length of more than 200 mm, preferably more than 500 mm, more preferably more than 1000 mm. Filaments may even be virtually endless, for example when formed by continuous extrusion and spinning of a filament through a spinning hole in a spinneret.

In general, it can be said that when a sound wave strikes a material surface, it either reflects or penetrates the material. Knowing that all materials can absorb sound waves to some extent the amount is expressed by the absorption coefficient; namely for complete reflection the value is 0 and for complete absorption the value is 1. If a soundwave is more reflected or more absorbed by a material can be assessed by values of acoustic impedance of the materials. The acoustic impedance is known to a person skilled in the art.

Preferably, the composite structure comprises an absorption coefficient at 250 Hz of at least 0.10, preferably of at least 0.15, more preferably of at least 0.20, and most preferably of at least 0.25 measured according to EN 10534-2.

Preferably, the composite structure comprises an absorption coefficient at 500 Hz of at least 0.3, preferably of at least 0.5, more preferably of at least 0.6, and most preferably of at least 0.7 measured according to EN 10534-2.

Preferably, the composite structure comprises an absorption coefficient at 1000 Hz of at least 0.3, preferably of at least 0.5, more preferably of at least 0.6, and most preferably of at least 0.7 measured according to EN 10534-2.

Another aspect which can influence the absorption coefficient of the composite is an air-gap thickness. The air-gap thickness has to be understood as the distance between the composite structure and a sound reflecting surface, e.g. between the composite structure and a shell of a car roof or a wall.

In a preferred embodiment, the composite structure positioned at a 10 mm, preferably a 25 mm, and more preferably at a 40 mm air-gap thickness comprises an absorption coefficient at 250 Hz of at least 0.10, preferably of at least 0.15, more preferably of at least 0.20, and most preferably of at least 0.25 measured according to EN 10534-2.

In a further preferred embodiment, the composite structure positioned at a 10 mm, preferably a 25 mm, and more preferably at a 40 mm air-gap thickness comprises an absorption coefficient at 500 Hz of at least 0.3, preferably of at least 0.5, more preferably of at least 0.6, and most preferably of at least 0.7 measured according to EN 10534-2.

In another preferred embodiment, the composite structure positioned at a 10 mm, preferably a 25 mm, and more preferably at a 40 mm air-gap thickness comprises an absorption coefficient at 1000 Hz of at least 0.3, preferably of at least 0.5, more preferably of at least 0.6, and most preferably of at least 0.7 measured according to EN 10534-2.

Without being bound to theory, it is believed that a composite positioned with an air-gap thickness can increase the absorption coefficient of the composite. Thereby, having an air-gap thickness of less than 10 mm would have marginal effect on an increase of absorption coefficient of the composite.

In a preferred embodiment, the honeycomb cells are polygonal cells with a number n of walls. The number n is at least 3 and goes in principle to infinite, which is circular. Preferably, the number n has an even value, more preferably n has the value of 4, 6 or 8, and most preferably n has the value of 6.

Preferably, the honeycomb structure is provided from an uncut flat body as disclosed in WO 2006/053407 so that the honeycomb structure has three dimensions: a length (L), a width (W), and a thickness (T). The length (L) of the honeycomb structure is the largest dimension corresponding to a machine direction (MD), in which the honeycomb structure is produced. The width (W) of the honeycomb structure is the second largest dimension corresponding to a cross machine direction (CMD), which is in plane with the machine direction but perpendicular to the machine direction. The thickness (T) is the third largest dimension and is perpendicular to the plane defined by the length (L) and the width (W).

In a preferred embodiment, the honeycomb structure has a thickness (T) of 2.0 mm to 20 mm, preferably of 3.0 mm to 10 mm, more preferably of 4 mm to 8 mm, as a result of spatial considerations, balanced with mechanical properties (e.g. bending stiffness) and overall composite weight (which should be as low as possible). Obviously, this composite structure should be an acoustic absorber in the desired frequency range.

Preferably, the honeycomb structure has a thickness (T) of at least 2.0 mm, more preferably of at least 3.0 mm, more preferably of at least 4 mm, and most preferably of at least 6 mm.

Preferably, the honeycomb structure has a thickness (T) of at most 20 mm, preferably of at most 15 mm, more preferably of at most 12 mm, even more preferably of at most 10 mm, and most preferably of at most 8 mm.

The honeycomb structure comprises a thermoplastic polymeric material, wherein the thermoplastic polymeric material is selected from a group comprising polyolefin like polyethylene (PE) and polypropylene (PP), polyester like polylactic acid (PLA), polyethylene terephthalate (PET), polyethylene terephthalate glycol modified (PET-G) and polybutylene terephthalate (PBT), polyether ketones like polyether ether ketone (PEEK) and polyether ketone ketones (PEKK), higher technical polymers such as polycarbonate (PC), polyphenylene sulfide (PPS) and polyvinyl butyral (PVB), and polyamides like polyamide 6,6 (PA6,6) and polyamide 6 (PA6), recycled polymers, in particular recycled polypropylene and polyethylene terephthalate and copolymers or blends thereof.

Within the scope of the invention, the polyethylene terephthalate glycol modified (PET-G) is to be understood as a co-polymer of polyethylene terephthalate and at least one other glycol terephthalate. Other glycols can be further aliphatic glycols such as butylene glycol, cyclic glycols such as cyclohexane dimethanol (CHDM) and/or aromatic glycols.

Without being bound to theory, it is believed that PET-G has a lower melting temperature due to the structural interferences of the different glycol units in the polymer.

Preferably, the thermoplastic polymeric material of the honeycomb structure can comprise fire retardant additives and/or inorganic fillers such as talcum, calcium, glass spheres, epoxies and nanoparticles.

In another preferred embodiment, the thermoplastic polymeric material of the honeycomb structure comprises a multi-layered laminate. An example of such a laminate can comprise copolymer and homopolymer of e.g. polyethylene terephthalate. Such a multi-layered laminate can be a PET-GAG, wherein the laminate comprise glycol modified polyethylene terephthalate (PET-G) and amorphous polyethylene terephthalate (PET-A). Without being bound to theory, it is believed that a multilayered laminate of PET-GAG can allow some degree of crystallization.

Within the scope of the invention PET-GAG has to be understood as a three-layer-laminate of polyethylene terephthalate glycol modified (PET-G), amorphous polyethylene terephthalate (PET-A) and a further polyethylene terephthalate glycol modified (PET-G). Without being bound to theory, it is believed that by using PET-GAG for the honeycomb structure, it combines the properties of a lower melting compound PET-G, which can have some degree of crystallization, and a compound PET-A comprising a low or no degree of crystallization, which could be advantageous for the molding of the composite structure as well as for the stability in case of bending stiffness. Further, due to the lower melting point of the PET-G in the PET-GAG, the bonding properties of the three-layered laminate can be enhanced.

The honeycomb structure comprises a first main surface and a second main surface, wherein the first main surface and the second main surface are extending in the length (L) and the width (W) of the honeycomb structure and the first main surface and the second main surface are on the opposite sides of the honeycomb structure. The main surfaces are built up at least by the edges of the walls of the honeycomb cells, and optionally by connecting areas (807, 808).

The honeycomb structure comprises a plurality of honeycomb cells, i.e. hexagonally shaped, delimited by walls in length (L), width (W) and height, wherein the height of the honeycomb cells corresponds to the thickness (T) of the honeycomb structure. Due to the delimitation of the honeycomb cells by the walls, the honeycomb cells of the honeycomb structure can have a diameter of 1.5 mm to 30 mm, preferably of 2.0 mm to 20 mm, more preferably of 3.0 mm to 15 mm, even more preferably between 4.0 and 10 mm, and most preferably between 5.0 and 8 mm which is measured as a perpendicular distance between two walls, which are located opposite and parallel to each other in the honeycomb cell.

In an embodiment, the honeycomb cells have a diameter of at least 1.5 mm, preferably of at least 2.0 mm, and most preferably of at least 3.0 mm, even more preferably of at least 4.0, and most preferably of at least 5.0 mm.

In another embodiment, the honeycomb cells have a diameter of at most 30 mm, preferably of at most 20 mm, more preferably of at most 20 mm, even more preferably of at most 10 mm, and most preferably of at most 8 mm.

Preferably, a ratio of the height of the honeycomb cells to the diameter of the honeycomb cells is between 0.4 and 2, preferably between 0.6 and 1.5, more preferably between 0.8 and 1.2.

The honeycomb cells of the honeycomb structure, which can be made according to WO 2006/053407, can comprise six walls which are delimiting the honeycomb cells. The delimiting walls in machine direction can comprise two walls (for example walls 802 and 803 in FIG. 8) and the other delimiting walls comprises only one honeycomb wall (for example honeycomb wall 801 or 804 in FIG. 8), which can be shared by both neighboring honeycomb cells. The walls delimiting the honeycomb cells in machine direction (MD) can be aligned substantially parallel and connected at only one edge of the walls.

In a preferred embodiment, the first nonwoven layer of fibers has a basis weight of at most 400 g/m², preferably of at most 300 g/m², more preferably of at most 250 g/m², even more preferably of at most 200 g/m², and most preferably of at most 150 g/m² measured according to ISO 9073-1.

Preferably, the first nonwoven layer of fibers has a thickness of at most 1.0 mm, preferably of at most 0.9 mm, more preferably of at most 0.8 mm, even more preferably of at most 0.7 mm, and most preferably of at most 0.6 mm measured according to ISO 9073-2:1995/Cor 1:1998 en.

In a preferred embodiment, the linear density of the fibers of the first nonwoven layer is not limited, but preferably fibers having a high linear density (high dtex) have a linear density of at least 5 dtex, preferably of at least 7 dtex, more preferably of at least 10 dtex, even more preferably of at least 15 dtex.

In another preferred embodiment, the linear density of the fibers of the first nonwoven layer of fibers is not limited, but preferably the fibers having a low linear density (low dtex) have a linear density of at most 15 dtex, preferably of at most 10 dtex, more preferably of at most 7 dtex, even more preferably of at most 5 dtex.

In a further preferred embodiment, the first nonwoven layer of fibers comprises low dtex fibers and high dtex fibers.

Without being bound to theory, it is believed that a composite structure comprising a first nonwoven layer of fibers with a high dtex can have the ability that sound waves undergo no or at least less reflection and can penetrate the composite structure and may be scattered. Further, by having high dtex in the first nonwoven layer of fibers, the composite structure can have an increased bending stiffness. Additionally, it is believed that composite structure comprising a first nonwoven layer of fibers of low dtex can have the ability that soundwaves undergo absorption. If the composite structure comprises a first nonwoven layer of fibers which comprises both fibers, low dtex fibers and high dtex fibers, the aforementioned properties can be combined.

In a preferred embodiment, the first nonwoven layer of fibers is free of kinks in an area in which the first nonwoven layer of fibers is bonded to the honeycomb structure. Preferably, the first nonwoven layer of fibers is free of kinks.

Without being bound to theory, it is believed that a first nonwoven layer of fibers which is free of kinks in the area in which the first nonwoven layer of fibers is bonded to the honeycomb structure can have the advantage that the bending stiffness is increased due to the fact, that forces, which are applied by bending the composite, are distributed over a larger part of the composite, preferably over the whole composite. In contrast, if for example the first nonwoven layer of fibers would be a cross-lapped nonwoven layer of fibers, the forces which are applied by bending the composite would affect solely a small part of the composite in which the first nonwoven layer of fibers is overlapping itself. This could also lead to an undesired damage of the composite wherein the first nonwoven layer of fibers can be, at least partially, delaminated from the composite.

In another preferred embodiment, the film has a thickness of 10 μm to 250 μm, preferably of 15 μm to 220 μm, and more preferably of 20 μm to 200, measured according to ISO 4593.

Without being bound to theory it is believed that by the addition of a film to the composite structure, the bending stiffness can be increased. Also, it is possible that the film, if located between the first nonwoven layer of fibers and/or the second nonwoven layer of fiber and the honeycomb structure, can increase the bonding between the first nonwoven layer of fibers and/or the second nonwoven layer of fiber and the honeycomb structure.

In another preferred embodiment, the film can be a continuous film or a discontinuous film, preferably, the discontinuous film is a slit film, a punctured film or a patterned film.

Without being bound to theory, it is believed that a discontinuous film can contribute to an increased bending stiffness as well as to an increased acoustic performance. It is further believed that due to the discontinuous film, the sound waves are less reflected by the discontinuous film and can penetrate the honeycomb structure, such that the soundwaves can be scattered and absorbed in the inner of the composite structure. However, it also believed that in both cases, the continuous film and the discontinuous film, the advantages (improved bending stiffness, improved acoustic performance) and the disadvantage of a sound wave reflection have to be balanced such that a composite structure is provided which meet the customer requirements. Further, it is believed that by using a discontinuous film in the composite structure, the processability of the composite structure is improved such that after the molding process (thermoforming process) the composite structure can be cooled down quicker and more uniform, which can prevent or at least reduces mechanical stresses in the composite structure, which may also support the bending stiffness of the composite structure.

Preferably, the film of the composite structure is composed of thermoplastic polymeric material selected from a group comprising polyolefin like polyethylene (PE) and polypropylene (PP), polyester like polylactic acid (PLA), polyethylene terephthalate (PET), polyethylene terephthalate glycol modified (PET-G) and polybutylene terephthalate (PBT), polyether ketones like polyether ether ketone (PEEK) and polyether ketone ketones (PEKK), higher technical polymers such as polycarbonate (PC), polyphenylene sulfide (PPS) and polyvinyl butyral (PVB), and polyamides like polyamide 6,6 (PA6,6) and polyamide 6 (PA6), recycled polymers, in particular recycled polypropylene and polyethylene terephthalate and copolymers or blends thereof.

Preferably, the thermoplastic polymeric material of the film can comprise fire retardant additives and/or inorganic fillers such as talcum, calcium, glass spheres, epoxies and nanoparticles.

Preferably, the film is a co-extruded film, wherein the film can comprise one or more thermoplastic polymeric materials. The one or more thermoplastic polymeric materials of the co-extruded film can comprise only one thermoplastic polymeric material, thermoplastic polymeric materials of the same class of thermoplastic polymeric material or chemically different thermoplastic polymeric material.

In a preferred embodiment, the thermoplastic polymeric material of the film comprises a multi-layered composite, preferably the multi-layered composite is PET-GAG.

Without being bound to theory, it is believed that by using PET-GAG for the film, it can combine the properties of a lower melting compound PET-G and a compound comprising a higher degree of crystallization, which could be advantageous for the molding of the composite structure as well as for the stability in case of bending stiffness.

Preferably, the thermoplastic polymeric material can also comprise the combination of groups of different polymers such as polyethylene terephthalate and polypropylene, polyethylene terephthalate and polyamide, and/or polyamide and polypropylene. Such combinations of different polymers are well known to the person skilled in the art.

For reinforcing the composite structure and supporting the bending stiffness of the composite structure, the composite structure can comprise reinforcing fibers. The reinforcing fibers can be located in the composite structure at any position between the honeycomb structure, the first nonwoven layer of fibers, the second nonwoven layer of fibers and the film. In another preferred embodiment, the film comprises reinforcing fibers.

Due to the reinforcing fibers in the film, the film can have improved mechanical properties such as tensile strength and tensile modulus, which can support the bending stiffness of the composite. Further, it is believed that if the reinforcing fibers in the film can support the moldability and processability as the reinforcing fibers can prevent or at least reduce sagging of the film due to heating in the molding process.

Preferably, the reinforcing fibers are comprised in a scrim, an open mesh, a nonwoven and/or a woven.

Within the scope of the invention, a scrim has to be understood as a laying or a weaving of fibers and the scrim is an open scrim. For being an open scrim, the scrim can have a cover factor of at most 0.5, preferably of at most 0.4, more preferably of at most 0.3, even more preferably of at most 0.2 and most preferably of at most 0.1.

Preferably, the reinforcing fibers of the film are composed of any suitable material. The material can be selected from a group consisting of inorganic material such as glass, basalt or steel or synthetic organic material such as high modulus polyethylene terephthalate or polyamides, or natural polymers such as rayon or lyocell or combinations thereof.

In a preferred embodiment, the linear density of the reinforcing is not limited, but preferably fibers having a high linear density (high dtex) have a linear density of at least 5 dtex, preferably of at least 7 dtex, more preferably of at least 10 dtex, even more preferably of at least 15 dtex.

In another preferred embodiment the first nonwoven layer of fibers comprises pores having a pore diameter of at least 0.1 μm, preferably of at least 0.2 μm, more preferably of at least 0.5 μm, and most preferably of at least 1.0 μm, as determined by microflow porometry, as for example discussed by Jena et al. in Advances in Pores Structure Evaluation by Porometry, Chemical Engineering & Technology, vol. 33, issue 8, pages 1241-1250, 21 Jul. 2010, using a PMI capillary Flow Porometer with a test size of 0.5 cm² using Galwick (surface tension of 15.9 mN/m).

Preferably, the first nonwoven layer of fibers comprises pores having a pore diameter of at most 400 μm, preferably of at most 300 μm, more preferably of at most 250 μm, and most preferably of at most 200 μm, as determined by microflow porometry, as for example discussed by Jena et al. in Advances in Pores Structure Evaluation by Porometry, Chemical Engineering & Technology, vol. 33, issue 8, pages 1241-1250, 21 Jul. 2010, using a PMI capillary Flow Porometer with a test size of 0.5 cm² using Galwick (surface tension of 15.9 mN/m).

Further, the first nonwoven layer of fibers can have a breaking strength of at least 15 N/5 cm, preferably of at least 20 N/5 cm, more preferably of at least 30 N/5 cm, even more preferably of at least 50 N/5 cm, and most preferably of at least 75 N/5 cm measured according to ISO 9073-3.

In a preferred embodiment, the first nonwoven layer of fibers has an elongation at break of at least 5%, preferably of at least 10%, more preferably of at least 20%, and most preferably of at least 30% measured according ISO 9073-3.

In a preferred embodiment, the second nonwoven layer of fibers has a basis weight of at most 400 g/m², preferably of at most 300 g/m², more preferably of at most 250 g/m², even more preferably of at most 200 g/m², and most preferably of at most 150 g/m² measured according to ISO 9073-1.

Preferably, the second nonwoven layer of fibers has a thickness of at most 1.0 mm, preferably of at most 0.9 mm, more preferably of at most 0.8 mm, even more preferably of at most 0.7 mm, and most preferably of at most 0.6 mm measured according to ISO 9073-2:1995/Cor 1:1998 en.

In a preferred embodiment, the linear density of the fibers of the second nonwoven layer is not limited, but preferably fibers having a high linear density (high dtex) have a linear density of at least 5 dtex, preferably of at least 7 dtex, more preferably of at least 10 dtex, even more preferably of at least 15 dtex.

In another preferred embodiment, the linear density of the fibers of the second nonwoven layer of fibers is not limited, but preferably the fibers having a low linear density (low dtex) have a linear density of at most 15 dtex, preferably of at most 10 dtex, more preferably of at most 7 dtex, even more preferably of at most 5 dtex.

In a further preferred embodiment, the second nonwoven layer of fibers comprises low dtex fibers and high dtex fibers.

Without being bound to theory, it is believed that a composite structure comprising a second nonwoven layer of fibers with a high dtex can have the ability that sound waves undergo no or at least less reflection and can penetrate the composite structure and may be scattered. Further, by having high dtex in the second nonwoven layer of fibers, the composite structure can have an increased bending stiffness. Additionally, it is believed that composite structure comprising a second nonwoven layer of fibers of low dtex can have the ability that soundwaves undergo absorption. If the composite structure comprises a second nonwoven layer of fibers which comprises both fibers, low dtex fibers and high dtex fibers, combines the aforementioned properties.

In a preferred embodiment, the second nonwoven layer of fibers is free of kinks in an area in which the second nonwoven layer of fibers is bonded to the honeycomb structure. Preferably, the second nonwoven layer of fibers is free of kinks.

Without being bound to theory, it is believed that a second nonwoven layer of fibers which is free of kinks in the area in which the second nonwoven layer of fibers is bonded to the honeycomb structure can have the advantage that the bending stiffness is increased due to the fact, that forces, which are applied by bending the composite, are distributed over a larger part of the composite, preferably over the whole composite. In contrast, if for example the second nonwoven layer of fibers would be a cross-lapped nonwoven layer of fibers, the forces which are applied by bending the composite would affect solely a small part of the composite in which the second nonwoven layer of fibers is overlapping itself. This could also lead to an undesired damage of the composite wherein the second nonwoven layer of fibers can be, at least partially, delaminated from the composite.

In another preferred embodiment the second nonwoven layer of fibers comprises pores having a pore diameter of at least 0.1 μm, preferably of at least 0.2 μm, more preferably of at least 0.5 μm, and most preferably of at least 1.0 μm, as determined by microflow porometry, as for example discussed by Jena et al. in Advances in Pores Structure Evaluation by Porometry, Chemical Engineering & Technology, vol. 33, issue 8, pages 1241-1250, 21 Jul. 2010, using a PMI capillary Flow Porometer with a test size of 0.5 cm² using Galwick (surface tension of 15.9 mN/m).

Preferably, the second nonwoven layer of fibers comprises pores having a pore diameter of at most 400 μm, preferably of at most 300 μm, more preferably of at most 250 μm, and most preferably of at most 200 μm, as determined by microflow porometry, as for example discussed by Jena et al. in Advances in Pores Structure Evaluation by Porometry, Chemical Engineering & Technology, vol. 33, issue 8, pages 1241-1250, 21 Jul. 2010, using a PMI capillary Flow Porometer with a test size of 0.5 cm² using Galwick (surface tension of 15.9 mN/m).

Further, the second nonwoven layer of fibers can have a breaking strength of at least 15 N/5 cm, preferably of at least 20 N/5 cm, more preferably of at least 30 N/5 cm, even more preferably of at least 50 N/5 cm, and most preferably of at least 75 N/5 cm measured according to ISO 9073-3.

In a preferred embodiment, the second nonwoven layer of fibers has an elongation at break of at least 5%, preferably of at least 10%, more preferably of at least 20%, and most preferably of at least 30% measured according ISO 9073-3.

In the case, the first nonwoven layer of fibers and/or the second nonwoven layer of fibers have a higher elongation at break, a faster deformation of the composite structure can be enabled, in particular in a mold.

In a preferred embodiment the first nonwoven layer of fibers and/or the second nonwoven layer of fibers are made of thermoplastic polymeric material.

Preferably, the fibers of the first nonwoven layer of fibers and/or the second nonwoven layer of fibers are filaments.

In an embodiment, the first nonwoven layer of fibers and/or the second nonwoven layer of fibers are made of mono-component fibers, two types of mono-component fibers and/or bicomponent fibers.

Preferably, the bicomponent fibers are of a sheath/core model, a concentric sheath/core model, an eccentric sheath/core model, an island-in-the-sea model, or a side-by-side model.

The cross section of the fibers of the first nonwoven layer of fibers and/or the second nonwoven layer of fibers can be circular, elliptic, egg-shaped, quadrangular, trigonal, trilobal, trapezoidal, or hollow circular.

Without being bound to theory, it is believed that fibers and filaments having a cross sectional shape different to circular can have an improved acoustic performance. It is further believed, that due to the different cross-sectional shape, the sound waves of the noise can be scattered in a beneficial manner. However, it is also believed, that fibers and filaments having a circular cross section can have an improved processability, such that the circular fibers and filaments are less sensitive to more harsh process conditions such as calendaring.

The first nonwoven layer of fibers and/or the second nonwoven layer of fibers can be made by any suitable process, such as a spun-laid process, air-laid process, wet-laid process, melt-blown process, or a carding process.

Preferably, the first nonwoven layer of fibers and/or the second nonwoven layer of fibers are made by a spun-laid process, wherein the fibers are made from a thermoplastic polymeric material.

Within the scope of the present invention the terms “spunbonded” and “spun-laid”, mean the production of a nonwoven layer of fibers in a one step process, wherein the fibers are extruded from a spinneret and subsequently laid down on a conveyor belt as a web of filaments and subsequently bonded the web to form a nonwoven layer of fibers, or by a two-step process, wherein filaments are spun and wound up on bobbins, preferably in the form of multifilament yarns, followed by the steps of unwinding the multifilament yarns and laying the filaments down on a conveyor belt as a web of filaments and bonding the web to form a nonwoven layer of fibers.

In the two step process it is possible to provide high linear density filaments with a high stretching ratio due to mechanical stretching instead of using air. This can improve the stiffness and moldability.

The advantage of a two-step process is that a linear density, a pore size and a distribution of the pore size can be tuned to match the desired properties. Further, it can be possible to use different fibers (e.g. of different denier, different cross section) in a single nonwoven layer of fibers. Additionally, it could be possible to construct a nonwoven layer of fibers, which can comprise multiple plies having different properties.

In the spun-laid process, bonding of the first nonwoven layer of fibers and/or the second nonwoven layer of fibers can be conducted by any suitable process, including calendaring, hydro entanglement, needling, ultrasonic bonding, chemical bonding, and other thermal bonding methods e.g. hot air bonding.

Preferably, the bonding of the first nonwoven layer of fibers and/or second nonwoven layer of fibers in the spun-laid process is made by hot air.

The advantage of a hot air bonding can be that the fibers of the first nonwoven layer of fibers and/or second nonwoven layer of fibers are not pressed, like for example in calendar bonding, thus, retaining their form. Consequently, the first nonwoven layer of fibers and/or the second nonwoven layer of fibers retain their structural openness. This has the effect that the soundwaves undergo no or at least less reflection by the first nonwoven layer of fibers and/or second nonwoven layer of fibers.

Preferably, the fibers comprised in the first nonwoven layer of fibers and/or in the second nonwoven layer of fibers can be composed of at least 60% of a thermoplastic polymeric material, preferably of at least 70% of a thermoplastic polymeric material, more preferably of at least 80% of a thermoplastic polymeric material, even more preferably of at least 90% of a thermoplastic polymeric material, an most preferably of at least 95% of a thermoplastic polymeric material.

The two types of mono-component fibers can comprise the same class of thermoplastic polymeric material or comprise chemically different thermoplastic polymeric material. Within the scope of the invention, the same class of thermoplastic polymeric material means that same monomeric units of the polymer can be used, but the thermoplastic polymeric material can be different by a different polymer chain length, by a different density of the thermoplastic polymeric material or by a different orientation of residues of the monomeric units, which can be isotactic, syndiotactic or atactic. Further, two types of mono component fibers can also be of a different cross-section shape, such as e.g. one of the two types of mono-component fibers are circular and the other trilobal.

Preferably, the thermoplastic polymeric materials of the two types of mono-component differ in melting temperature of at least 10° C., preferably of at least 20° C., and most preferably of at least 30° C.

In a preferred embodiment, the core and the sheath of the bicomponent fibers comprise the same class of thermoplastic polymeric material or comprise different thermoplastic polymeric material.

Preferably, the thermoplastic polymeric materials of the core and the sheath of the bicomponent fibers differ in melting temperature of at least 10° C., preferably of at least 20° C., and most preferably of at least 30° C.

In a preferred embodiment the thermoplastic polymeric material of the fibers of the first nonwoven layer of fibers and/or the second nonwoven layer of fibers is selected from a group comprising polyolefin like polyethylene (PE) and polypropylene (PP), polyester like polylactic acid (PLA), polyethylene terephthalate (PET), polyethylene terephthalate glycol modified (PET-G) and polybutylene terephthalate (PBT), polyether ketones like polyether ether ketone (PEEK) and polyether ketone ketones (PEKK), higher technical polymers such as polycarbonate (PC), polyphenylene sulfide (PPS) and polyvinyl butyral (PVB), and polyamides like polyamide 6,6 (PA6,6) and polyamide 6 (PA6), recycled polymers, in particular recycled polypropylene and polyethylene terephthalate and copolymers of blends thereof.

In a preferred embodiment, the bicomponent fiber comprises two polymers of different chemical structure, wherein the polymers have little adhesion to each other.

This can have the effect that the polymers of the bicomponent fiber, in particular the core/sheath type of a bicomponent fiber, can move relative to each other, which supports the moldability of the composite structure.

Preferably, the thermoplastic polymeric material of the first nonwoven layer of fibers and/or second nonwoven layer of fibers can comprise fire retardant additives and/or inorganic fillers such as talcum, calcium, glass spheres, epoxies and nanoparticles.

Preferably, the thermoplastic polymeric material can also comprise the combination of groups of different polymers such as polyethylene terephthalate and polypropylene, polyethylene terephthalate and polyamide, and/or polyamide and polypropylene. Such combinations of different polymers are well known to the person skilled in the art.

In a preferred embodiment, the first nonwoven layer of fibers and/or the second nonwoven layer of fibers can be made of a single fiber or of a combination of different fibers.

Preferably, the first nonwoven layer of fibers and/or the second nonwoven layer of fibers comprises one or more plies of fibers.

In another preferred embodiment, the fibers of the one or more plies are the same fibers or are different fibers.

The plies of fibers can comprise fibers of different types, e.g. mono-component fibers, bicomponent fibers, of different polymeric composition, of different linear density, different stretching ratio, different modulus, of different elongation at break, of a different thermoplastic polymeric material and/or of a different cross-sectional shape.

In another embodiment, the plies of fibers of the first nonwoven layer of fibers and/or second nonwoven layer of fibers can be of different fabric, preferably each of the plies are a nonwoven fabric, a woven fabric, a knitted fabric, a scrim, and/or a unidirectional layer.

In a preferred embodiment, the first nonwoven layer of fibers and/or the second nonwoven layer of fibers comprises plies of fibers, wherein a first ply of fibers of the first nonwoven layer of fibers and/or the second nonwoven layer of fibers is located adjacent and/or closest to the honeycomb structure, a second ply of fibers is located adjacent and closest to the first ply of fibers, and a third ply of fibers is located adjacent and closest to the second ply of fibers.

Preferably, the fibers of a second ply of fibers between a first ply of fibers and a third ply of fibers of the first nonwoven layer of fibers and/or the second nonwoven layer of fibers comprise a non-circular cross section.

Without being bound to theory, it is believed that a non-circular cross section of the fibers of the second ply of fibers of the first nonwoven layer of fibers and/or the second nonwoven layer of fibers increases the acoustic performance of the composite structure.

Preferably, the first nonwoven layer of fibers and/or the second nonwoven layer of fibers comprise plies of fibers of different linear density.

Accordingly, a combination of plies having a high dtex and a low dtex is possible.

In a preferred embodiment, the first nonwoven layer of fibers and/or the second nonwoven layer of fibers comprises a first ply of fibers having a high dtex, a second ply of fibers having a low dtex, and a third ply of fibers having a high dtex.

Without being bound to theory, it is believed that by the combination of the high dtex and low dtex plies of fibers the composite structure can be able to let the sound waves penetrate into the composite structure with no or at least less reflection by the high dtex plies of fiber and the sound waves can be scattered.

Moreover, the high dtex plies of fibers can enable the composite structure of having a high bending stiffness.

Further, the sound waves can be scattered, and the sound energy of the sound waves can be absorbed by the ply of fibers having a low dtex.

Accordingly, the composite structure can have the advantageous combination of being light weight, having an improved acoustic performance, moldability and bending stiffness.

In a further preferred embodiment, the fibers of the first ply of fibers of the first nonwoven layer of fibers and/or the second nonwoven layer of fibers comprises a thermoplastic polymeric material which is from the same class of thermoplastic polymeric material as the thermoplastic polymeric material of the honeycomb structure.

It is believed that by having the same class of thermoplastic polymeric material in the first ply of fibers of the first nonwoven layer of fibers and/or the second nonwoven layer of fibers as it is comprised in the honeycomb structure, the bonding between the honeycomb structure and the first nonwoven layer of fibers and/or the second nonwoven layer of fibers can be improved.

In another preferred embodiment, the fibers of the second ply of fibers and the third ply of fibers of the first nonwoven layer of fibers and/or the second nonwoven layer of fibers comprises polyester or co-polyester as thermoplastic polymeric material.

Without being bound to theory, it is believed that by comprising polyester and/or co-polyester in the second and/or third ply of fibers of the first nonwoven layer of fibers and/or second nonwoven layer of fibers the bending stiffness of the composite structure can be increased.

Preferably, the fibers of each ply of fibers in the first nonwoven layer of fibers and/or second nonwoven layer of fibers may be not strictly located in only one ply of fibers, such that the fibers may penetrate neighboring plies of fibers or be partially intermingled with the neighboring plies of fibers.

In a preferred embodiment, the nonwoven layer of fibers comprises fibers of different type, different cross sections and/or different polymeric composition. The fibers of different type, cross sections and/or of polymeric composition can be randomly intermingled in the first nonwoven layer of fibers and/or in the second nonwoven layer of fibers, such that the first nonwoven layer of fibers and/or the second nonwoven layer of fibers can be made by only one ply of fibers, wherein the fibers are mixed.

Preferably, the honeycomb structure, the film, the first nonwoven layer of fibers and the second are nonwoven layer of fibers comprise different thermoplastic polymeric materials, the same class of thermoplastic polymeric material or the same thermoplastic polymeric material.

In the case the honeycomb structure, the first nonwoven layer of fibers, the second nonwoven layer of fibers, and optionally the film of the composite structure comprises the same thermoplastic polymeric materials. Without being bound to theory, it is believed that the bond strength between the components can be increased.

In a preferred embodiment, a half of the honeycomb cells are closed on the side of the first main surface of the honeycomb structure and a half of the honeycomb cells are closed on the side of the second main surface, wherein every honeycomb cell is open at one side.

The honeycomb cells can be closed at one side by a cover of thermoplastic polymeric material, which is originating from the thermoplastic polymeric material of the preformed, folded film of the honeycomb structure according to WO 2006/053407.

Further, the honeycomb cells, which are open on at least one side can be filled with a material, which is selected from group comprising thixotropic liquids, fibrous material, micro fibrous material, porous particulate systems, and nano-porous particulate systems such as aerogels.

Preferably, only one half of the honeycomb cells are filled with the material, which can be the half of the honeycomb cells which are closed at the first main surface or the honeycomb cells which are closed at the second main surface.

In a preferred embodiment, the honeycomb cells are filled randomly or following patterns with the material so that a part of the honeycomb cells closed at the first main surface and a part of the honeycomb cells closed at the second main surface are filled with the material as well as a part of the honeycomb cells closed at the first main surface and a part of the honeycomb cells closed at the second main are free of the material.

In the case of randomly filled honeycomb cells it is preferred that at least 20%, preferably at least 30%, more preferably at least 40%, even more preferably at least 50%, most preferably at least 60% and even most preferably at least 70% of the honeycomb cells are filled with a material.

In a preferred embodiment, the composite structure comprises a honeycomb structure made of polyamide and the film is made of a co-polyamide, the nonwoven layer of fibers is located in the film and is composed of fibers made of polyamide and/or polyethylene terephthalate.

In another preferred embodiment, the composite structure comprises a honeycomb structure made of polyethylene terephthalate and the film is made of a laminate comprising co-polyethylene terephthalate and co-polyamide, the nonwoven layer of fibers is located in the film and is composed of fibers made of polyethylene terephthalate.

The object is also solved by a method for manufacturing the composite structure, also comprising the aforementioned embodiments, by providing a honeycomb structure having a first main surface and a second main surface, bonding a first nonwoven layer to the honeycomb structure at the first main surface or the second main surface of the honeycomb structure, wherein the honeycomb structure and the first nonwoven layer of fibers comprise thermoplastic polymeric materials, wherein the honeycomb structure is provided from an uncut flat body and comprises a plurality of honeycomb cells, and the honeycomb cells are delimited by walls, characterized in that a film, comprising a thermoplastic polymeric material, is provided in the composite structure between the first nonwoven layer of fibers and the honeycomb structure and/or bonded to the honeycomb structure at the main surface opposite to the main surface at which the first nonwoven layer of fibers is bonded to the honeycomb structure.

The object is also solved by an interior lining comprising a composite structure which can comprise the aforementioned embodiments.

Without being bound to theory, next to the above mentioned advantages, an interior lining comprising the composite structure can have an improved appearance, as the structural contours of the honeycomb structure are not visible to the naked eye.

Preferably, the interior lining comprises at least one decorative layer. The decorative layer can be made of any suitable material, such as a foam or any suitable fabric or suitable combinations thereof.

In a preferred embodiment, the interior lining is an automotive interior lining.

The object is also solved by an automotive headliner comprising an interior lining.

### EXAMPLES

### Example 1 (E1)

The composite structure of E1 comprises:
a honeycomb structure comprising polypropylene (PP),
a first nonwoven layer of fibers comprising of concentric core/sheath bicomponent filaments, wherein the core comprises polyethylene terephthalate (PET) and the sheath comprises polypropylene (PP), having a weight of 50 g/m²
a second nonwoven layer of fibers comprising of concentric core/sheath bicomponent filaments, the core comprises polyethylene terephthalate (PET) and the sheath comprises polypropylene (PP), having a weight of 100 g/m²
a first film located between the first nonwoven layer of fibers and the honeycomb structure comprising polypropylene (PP) having a thickness of 50 μm.

### Example 2 (E2)

The composite structure of E2 comprises:
a honeycomb structure comprising polypropylene (PP),
a first nonwoven layer of fibers comprising of concentric core/sheath bicomponent filaments, wherein the core comprises polyethylene terephthalate (PET) and the sheath comprises polypropylene (PP), having a weight of 50 g/m²
a second nonwoven layer of fibers comprising of concentric core/sheath bicomponent filaments, the core comprises polyethylene terephthalate (PET) and the sheath comprises polypropylene (PP), having a weight of 50 g/m²
a first film located between the first nonwoven layer of fibers and the honeycomb structure comprising polypropylene (PP) having a thickness of 50 μm.
a second film located between the second nonwoven layer of fibers and the honeycomb structure comprising polypropylene (PP) having a thickness of 50 μm.

### Comparative Example 1 (CE1)

The composite structure of CE1 comprises:
a honeycomb structure comprising polypropylene (PP),
a first nonwoven layer of fibers comprising of concentric core/sheath bicomponent filaments, wherein the core comprises polyethylene terephthalate (PET) and the sheath comprises polypropylene (PP), having a weight of 100 g/m²
a second nonwoven layer of fibers comprising of concentric core/sheath bicomponent filaments, the core comprises polyethylene terephthalate (PET) and the sheath comprises polypropylene (PP), having a weight of 100 g/m²

### Comparative Example 2 (CE2)

The composite structure of CE2 comprises:
a honeycomb structure comprising polypropylene (PP),
a first film located between the first nonwoven layer of fibers and the honeycomb structure comprising polypropylene (PP) having a thickness of 100 μm.
a second film located between the second nonwoven layer of fibers and the honeycomb structure comprising polypropylene (PP) having a thickness of 100 μm.

### Example 3 (E3)

The composite structure of E3 comprises:
a honeycomb structure comprising polypropylene (PP),
a first nonwoven layer of fibers comprising polyethylene terephthalate filaments having a weight of 35 g/m²
a second nonwoven layer of fibers comprising polyethylene terephthalate filaments having a weight of 35 g/m²
a first film located between the first nonwoven layer of fibers and the honeycomb structure comprising polypropylene (PP) having a thickness of 50 μm.
a second film located between the second nonwoven layer of fibers and the honeycomb structure comprising polypropylene (PP) having a thickness of 50 μm.

### Example 4 (E4)

The composite structure of E4 comprises:
a honeycomb structure comprising polyethylene terephthalate (PET),
a first nonwoven layer of fibers comprising polyethylene terephthalate filaments having a weight of 35 g/m²
a second nonwoven layer of fibers comprising polyethylene terephthalate filaments having a weight of 35 g/m²
a first film located between the first nonwoven layer of fibers and the honeycomb structure comprising polyethylene terephthalate (PET) having a thickness of 110 μm.
a second film located between the second nonwoven layer of fibers and the honeycomb structure comprising polyethylene terephthalate (PET) having a thickness of 110 μm.

### Example 5 (E5)

The composite structure of E5 comprises:
a honeycomb structure comprising polyethylene terephthalate (PET),
a first nonwoven layer of fibers comprising of concentric core/sheath bicomponent filaments, wherein the core comprises polyethylene terephthalate (PET) and the sheath comprises a co-polyester of polyethylene terephthalate, having a weight of 75 g/m²
a second nonwoven layer of fibers comprising of concentric core/sheath bicomponent filaments, wherein the core comprises polyethylene terephthalate (PET) and the sheath comprises a co-polyester of polyethylene terephthalate, having a weight of 75 g/m²
a first film located between the first nonwoven layer of fibers and the honeycomb structure comprising polyethylene terephthalate (PET) having a thickness of 110 μm.
a second film located between the second nonwoven layer of fibers and the honeycomb structure comprising polyethylene terephthalate (PET) having a thickness of 110 μm.

### Comparative Example 3 (CE3)

The composite structure of CE3 comprises:
a honeycomb structure comprising polyethylene terephthalate (PET),
a first nonwoven layer of fibers comprising of concentric core/sheath bicomponent filaments, wherein the core comprises polyethylene terephthalate (PET) and the sheath comprises a co-polyester of polyethylene terephthalate, having a weight of 75 g/m²
a second nonwoven layer of fibers comprising of concentric core/sheath bicomponent filaments, wherein the core comprises polyethylene terephthalate (PET) and the sheath comprises a co-polyester of polyethylene terephthalate, having a weight of 75 g/m²
a first film located between the first nonwoven layer of fibers and the honeycomb structure comprising polyethylene terephthalate (PET) having a thickness of 75 μm.
a second film located between the second nonwoven layer of fibers and the honeycomb structure comprising polyethylene terephthalate (PET) having a thickness of 75 μm.

### Example 6 (E6)

The composite structure of E6 comprises:
a honeycomb structure comprising polypropylene (PP),
a first nonwoven layer of fibers comprising of concentric core/sheath bicomponent filaments, wherein the core comprises polyethylene terephthalate (PET) and the sheath comprises polyamide 6 (PA6), having a weight of 75 g/m²
a second nonwoven layer of fibers comprising of concentric core/sheath bicomponent filaments, the core comprises polyethylene terephthalate (PET) and the sheath comprises polyamide 6 (PA6), having a weight of 50 g/m²
a first film located between the first nonwoven layer of fibers and the honeycomb structure comprising polypropylene (PP) having a thickness of 100 μm.
a second film located between the second nonwoven layer of fibers and the honeycomb structure comprising polypropylene (PP) having a thickness of 100 μm.

### Comparative Example 4 (CE4)

The composite structure of CE4 comprises:
a honeycomb structure comprising polypropylene (PP),

TABLE 1

| | Thickness | Weight | Load at | Load at 5 |
|---|---|---|---|---|
| Example | [mm] | [g/m²] | break [N] | mm sag [N] |
| E1 | 3.5 | 614 | 13.9 | 9.4 |
| E2 | 3.3 | 606 | 17.6 | 12.0 |
| CE1 | 3.7 | 615 | 11.7 | 9.6 |
| CE2 | 3.5 | 617 | 18.2 | 13.8 |
| E3 | 2.8 | 648 | 13.1 | 6.6 |
| E4 | 10.4 | 1305 | 84.6 | 42.5 |
| E5 | 10.4 | 1350 | 95.4 | 58.9 |
| CE3 | 10.4 | 1213 | 91.0 | 48.9 |
| E6 | 5.3 | 908 | 32.5 | 13.3 |
| CE4 | 5.1 | 552 | 7.8 | 2.9 |

As can be seen by the Examples E1, E2 and the comparative example CE1, that the addition of a film (i.e. E1, load at break 13.9), respectively of 2 films (i.e. E2, load at break 17.6 N) improves the possible load at break. Thus, the bending stiffness is improved.

By the Examples E4, E5 and the Comparative Example CE3 it can be seen that the weight of the first and/or second nonwoven layer of fibers contribute to the bending stiffness, as a higher weight (i.e. E5, load at break 95.4 N) of the first and/or second nonwoven layer of fibers lead to an increased load at break, in view of a lower weight (i.e. E4, load at break 84.6 N). Further, also the weight of the first and/or second film can contribute to the bending stiffness, as a higher weight of the films lead to a higher load at break (E5: 95.4 N), wherein a lower weight of the films lead to a decrease of the load at break (CE 3: 91.0 N)

These concepts are validated by comparing the Example 6, which has the highest load at break (i.e. 32.5 N), in view of the Comparative Example 5, wherein CE 4 (load at break 7.8 N) additionally does not comprise a first and second film.

### FIGURES

The description of the figures and the figures itself have to be understood as embodiments of the invention and not as limiting features.

FIG. 1a-b shows a cross section view of the composite structure.

FIGS. 2 to 7 show plan views of different honeycomb structures.

FIG. 8 shows a perspective view of a section of a preformed film in a folding process.

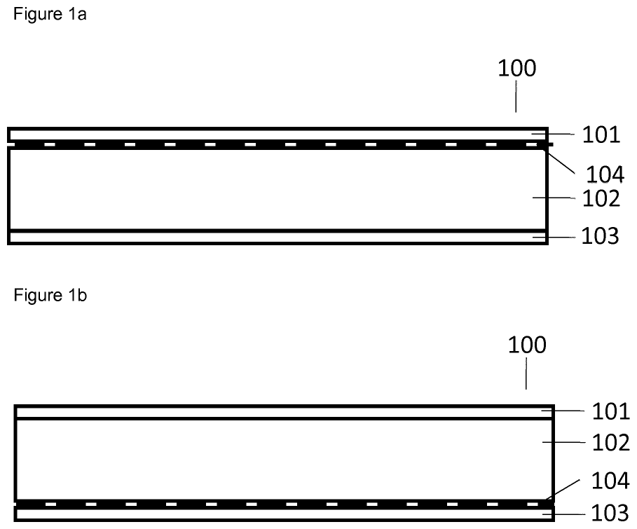

FIG. 1a shows a cross sectional view of the composite structure (100) comprising a honeycomb structure (102), a first nonwoven layer of fibers (101) and a second nonwoven layer of fibers (103) and a film (104). Accordingly, the first main surface (not shown) of the honeycomb structure (102) is faced to the first nonwoven layer of fibers (101) and the second main surface (not shown) of the honeycomb structure (102) is faced to the second nonwoven layer of fibers (103). The film (104) is located between the first main surface (not shown) of the honeycomb structure (102) and the first nonwoven layer of fibers (101).

FIG. 1b shows a cross sectional view of the composite structure (100) comprising a honeycomb structure (102), a first nonwoven layer of fibers (101) and a second nonwoven layer of fibers (103) and a film (104). Accordingly, the first main surface (not shown) of the honeycomb structure (102) is faced to the first nonwoven layer of fibers (103) and the second main surface (not shown) of the honeycomb structure (103) is faced to the second nonwoven layer of fibers (101). The film (104) is located between the second main surface (not shown) of the honeycomb structure (102) and the second nonwoven layer of fibers (103).

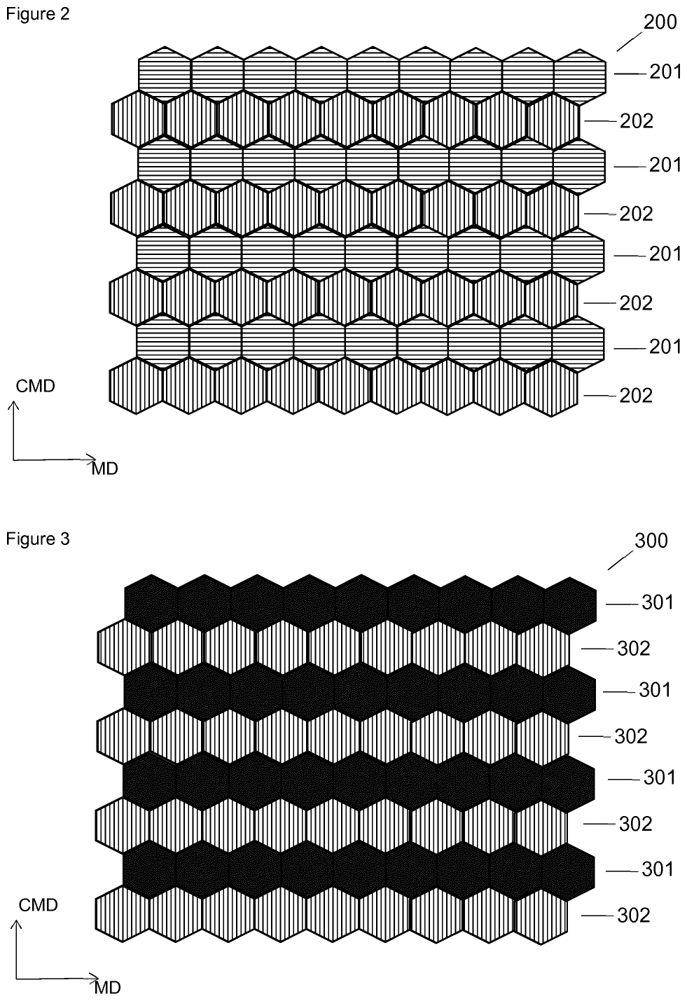

FIG. 2 shows a plan view of a honeycomb structure (200), wherein the honeycomb structure comprises rows of honeycombs (201) and (202). The honeycomb rows (201) and (202) are oriented in the direction of the machine direction (MD) and the honeycomb cells of the honeycomb rows (201) and (202) are alternatingly opened and closed to a first main surface or a second main surface main surfaces (not shown) of the honeycomb structure (200). All honeycomb cells of the honeycomb rows (201) are opened at a first main surface (not shown) of the honeycomb structure (200) and all the honeycomb cells of the honeycomb rows (202) are opened to a second main surface of the honeycomb structure (200).

FIG. 3 shows a plan view of a honeycomb structure (300), wherein a half of the honeycomb cells of the honeycomb structure (300) are filled with a material (301). In this figure only the honeycomb rows (301) are filled, which means that only honeycombs opened to a first main surface (not shown) of the honeycomb structure (300) are filled.

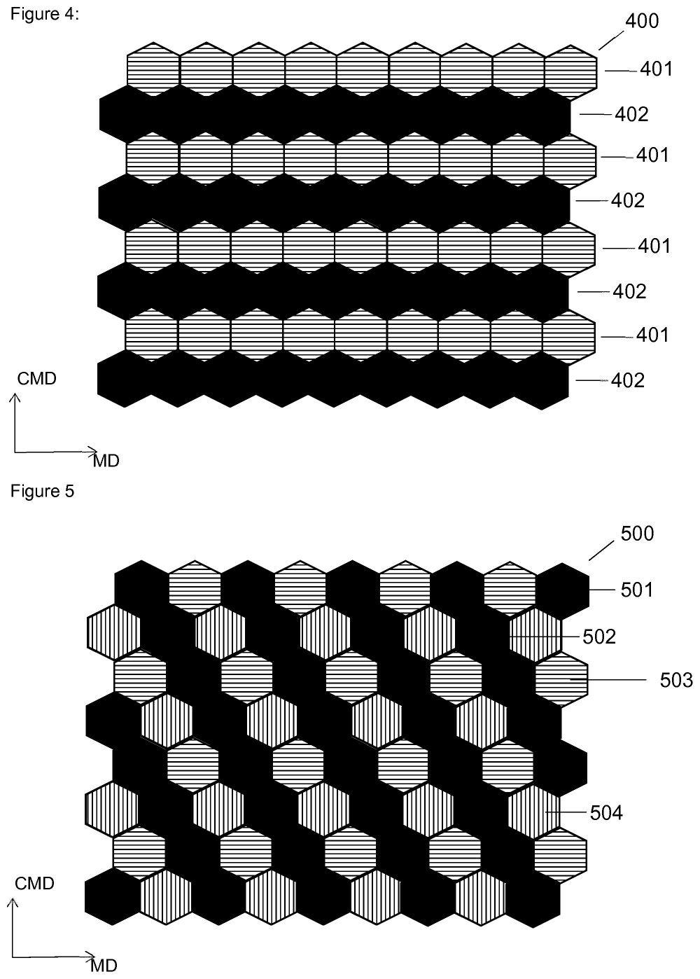

FIG. 4 shows a plan view of a honeycomb structure (400) wherein a half of the honeycomb cells of the honeycomb structure (400) are filled with a material (402). In this figure only the honeycomb rows (402) are filled, which means that only honeycombs opened to a second main surface (not shown) of the honeycomb structure (400) are filled. In comparison to FIG. 3, FIG. 4 shows that the other half of the honeycomb cells are filled with a material.

FIG. 5 shows a plan view of a honeycomb structure (500), wherein a half of the honeycomb cells of the honeycomb structure (500) are filled with a material (501) and (502), wherein the filling of the honeycomb cells comprises a pattern which is diagonal to the machine direction (MD) and to the cross machine direction (CMD). The filled honeycomb cells (501) are opened to a first main surface (not shown) of the honeycomb structure (500) and the filled honeycomb cells (502) are opened to the second main surface (not shown) of the honeycomb structure (500).

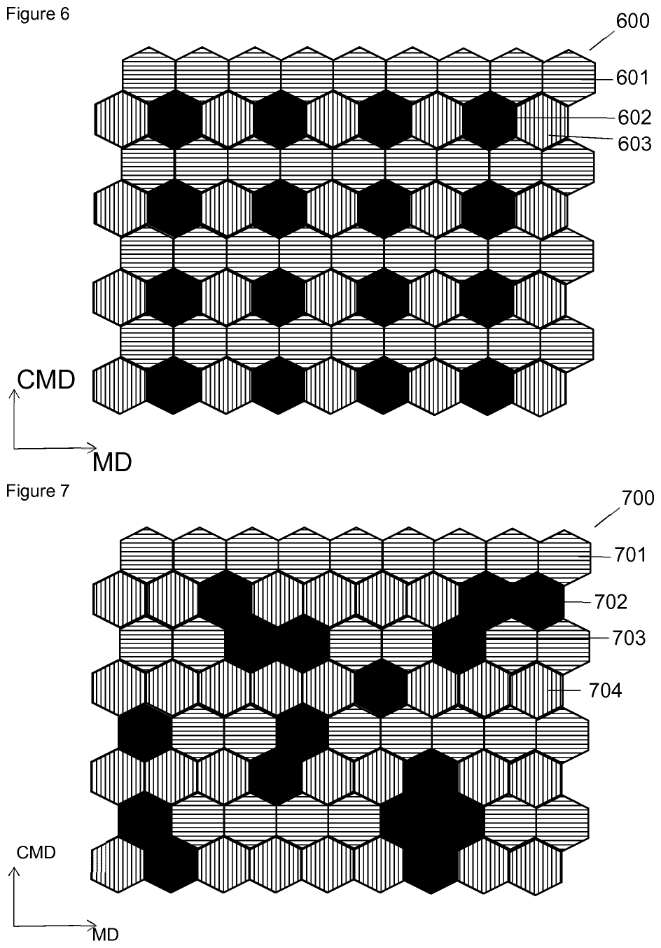

FIG. 6 shows a plan view of a honeycomb structure (600) comprising honeycomb cells (601), wherein all honeycomb cells (601) are opened to a first main surface (not shown) of the honeycomb structure (600) and are not filled with a material. The honeycomb cells (602) are opened to a second main surface (not shown) in view of the honeycomb cells (601) and are filled with a material, further, the honeycomb cells (603) are also opened a second main surface of the honeycomb structure (600) in view of the honeycomb cells (601) and are not filled with a material. The filled honeycomb cells (602) shows a pattern, wherein only every second honeycomb cell of all honeycomb cells, which are opened to a second main surface (not shown) of the honeycomb structure (600) in view of the honeycomb cells (601).

FIG. 7 shows a plan view of a honeycomb structure (700) comprising honeycomb cells which are not filled with material (701) and (704) and honeycomb cells which are filled with a material (702) and (703). The filled honeycomb cells (702) and (703) are randomly distributed in the honeycomb structure (700) and the filled honeycomb cells (703) have its opening to a first main surface (not shown) of the honeycomb structure (700) and the filled honeycomb cells (702) have its opening on to a second main surface (not shown) of the honeycomb structure (700). Also, the not filled honeycomb cells (701) have its opening to a first main surface (not shown) of the honeycomb structure (700) and the also not filled honeycomb cells (704) have its opening to the second main surface (not shown) of the honeycomb structure (700).

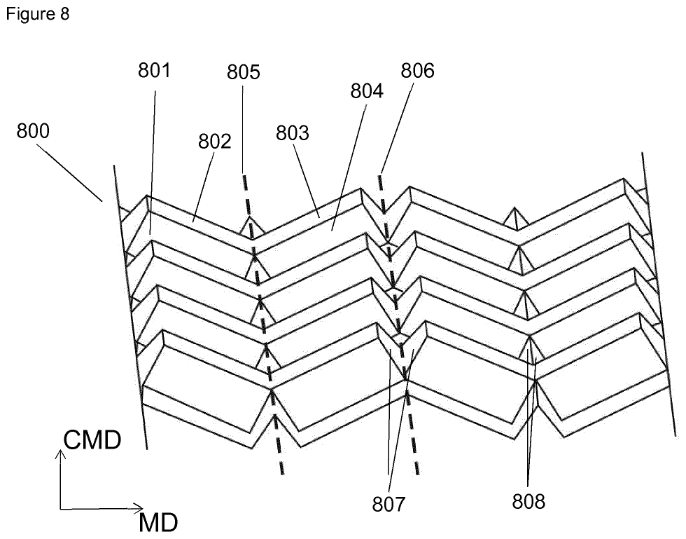

FIG. 8 shows a perspective view of a section of a deformed film (800), wherein the folding of the deformed film is in the beginning. After the folding is completed the walls (802) and (803) are the walls which are delimiting the honeycomb cells (not shown) in machine direction (MD) and the walls (802) and (803) aligned substantially parallel, wherein the walls (802) and (803) are connected only at the shared honeycomb cell boundary ribs (dashed lines 805 and 806). The shared honeycomb cell boundary ribs are located in the first main surface (not shown) and/or in the second main surface (not shown) of the honeycomb structure after complete folding of the preformed film (800). The walls which are not delimiting in machine direction (MD) comprises only one honeycomb wall (801) or (804). Further, connecting areas (807 and 808) are shown, which are closing the honeycomb cells (not shown) after full folding in one main surface. Thereby, the connecting areas (807 and 808) are located in different mains surfaces of the honeycomb structure.

1. A composite structure for interior lining comprising a honeycomb structure having a first main surface and a second main surface, a first nonwoven layer of fibers bonded to the honeycomb structure at the first main surface or the second main surface, wherein the honeycomb structure and the first nonwoven layer of fibers comprise thermoplastic polymeric materials, wherein the honeycomb structure is provided from an uncut flat body and comprises a plurality of honeycomb cells, and the honeycomb cells are delimited by walls, wherein a film, comprising a thermoplastic polymeric material, is located in the composite structure between the first nonwoven layer of fibers and the honeycomb structure and/or bonded to the honeycomb structure at the main surface opposite to the main surface at which the first nonwoven layer of fibers is bonded to the honeycomb structure.

2. The composite structure according to claim 1, wherein a second nonwoven layer of fibers, which comprises thermoplastic material, is bonded to the honeycomb structure at the main surface opposite to the main surface at which the first nonwoven layer of fibers is bonded to the honeycomb structure.

3. The composite structure according to claim 1, wherein the film has a thickness of 10 μm to 250 μm measured according to ISO 4593.

4. The composite structure according to claim 2, wherein the first nonwoven layer of fibers and/or the second nonwoven layer of fibers comprise pores having a pore diameter of 0.1 μm to 400 μm, as determined by microflow porometry, using a PMI capillary Flow Porometer with a test size of 0.5 cm² using Galwick (surface tension of 15.9 mN/m).

5. The composite structure according to claim 2, wherein the first nonwoven layer of fibers and/or the second nonwoven layer of fibers comprise one or more plies of fibers.

6. The composite structure according to claim 5, wherein the fibers of the one or more plies are the same fibers or are different fibers.

7. The composite structure according to claim 2, wherein the first nonwoven layer of fibers and/or the second nonwoven layer of fibers has a breaking strength of at least 15 N/5 cm measured according to ISO 9073-3.

8. The composite structure according to claim 2, wherein the first nonwoven layer of fibers and/or the second nonwoven layer of fibers comprises mono-component fibers, two types of mono-component fibers and/or bicomponent fibers.

9. The composite structure according to claim 8, wherein the bicomponent fibers are core/sheath bicomponent fibers, wherein the core and the sheath and the mono-component fibers of the two types of mono-component fibers comprise the same class of thermoplastic polymeric material or comprise chemically different thermoplastic polymeric materials.

10. The composite structure according to claim 8, wherein the different thermoplastic polymeric materials comprised in the two mono component fibers and/or in the bicomponent fibers have a different melting temperature of at least 10° C.

11. The composite structure according to claim 1, wherein the honeycomb structure has a thickness of 2.0 mm to 20 mm.

12. The composite structure according to claim 1, wherein the honeycomb cells of the honeycomb structure have a diameter of 3.0 mm to 30 mm, which is measured as a perpendicular distance between two walls which are located opposite to each other in the honeycomb cell.

13. The composite structure according to claim 1, wherein the thermoplastic polymeric material is selected from a group comprising polyolefin like polyethylene (PE) and polypropylene (PP), and recycled polypropylene polyester like polylactic acid (PLA), polyethylene terephthalate (PET), recycled polyethylene terephthalate, polyethylene terephthalate glycol modified (PET-G) and polybutylene terephthalate (PBT), polyether ketones like polyether ether ketone (PEEK) and polyether ketone ketones (PEKK), higher technical polymers such as polycarbonate (PC), polyphenylene sulfide (PPS) and polyvinyl butyral (PVB), and polyamides like polyamide 6,6 (PA6,6) and polyamide 6 (PA6) and copolymers of blends thereof.

14. The composite structure according to claim 2, wherein the honeycomb structure, the film, the first nonwoven layers of fibers and the second are nonwoven layers of fibers comprise different thermoplastic polymeric materials, the same class of thermoplastic polymeric material or the same thermoplastic polymeric material.

15. The composite structure according to claim 1, wherein a half of the honeycomb cells are closed on the side of the first main surface of the honeycomb structure and a half of the honeycomb cells are closed on the side of the second main surface, wherein every honeycomb cell is open at one side.

16. The composite structure according to claim 1, wherein the honey comb cells are filled with a material selected from a group comprising thixotropic liquids, fibrous material, micro fibrous material, porous particulate systems, and nano-porous particulate systems such as aerogels.

17. A method for manufacturing a composite structure by providing a honeycomb structure having a first main surface and a second main surface, bonding a first nonwoven layer to the honeycomb structure at the first main surface or the second main surface of the honeycomb structure, wherein the honeycomb structure and the first nonwoven layer of fibers comprise thermoplastic polymeric materials, wherein the honeycomb structure is provided from an uncut flat body and comprises a plurality of honeycomb cells, and the honeycomb cells are delimited by walls, wherein a film, comprising a thermoplastic polymeric material, is provided in the composite structure between the first nonwoven layer of fibers and the honeycomb structure and/or bonded to the honeycomb structure at the main surface opposite to the main surface at which the first nonwoven layer of fibers is bonded to the honeycomb structure.

18. An interior lining comprising a composite structure according to claim 1.

19. An automotive headliner comprising an interior lining according to claim 18.
